(19) United States
(12) Patent Application Publication
(10) Pub. No.: US 2018/0165707 A1
(43) Pub. Date: Jun. 14, 2018

(54) Methods and Systems for Adjusting Demographic and Interest Targeting Parameters for an Advertising Campaign

(71) Applicant: FACEBOOK, INC., Menlo Park, CA (US)

(72) Inventors: Wenjing Wang, Foster City, CA (US); Britt Friede, San Francisco, CA (US); Nicholas Matthew Heise, Mississauga (CA); Cynthia Huynh, Fremont, CA (US); Emily Anne Janzer, Mountain View, CA (US); Jessica Barone, Menlo Park, CA (US); Maryanna Quigless, San Francisco, CA (US)

(21) Appl. No.: 15/418,606

(22) Filed: Jan. 27, 2017

Related U.S. Application Data
(63) Continuation-in-part of application No. 29/587,671, filed on Dec. 14, 2016.

(51) Int. Cl. G06Q 30/02

(52) U.S. Cl. CPC G06Q 30/0244; H04L 67/12; G06Q 30/0251

(57) ABSTRACT

A client device displays to a user who manages advertisements, a first option of viewing screens showing a plurality of tips for setting demographic parameters for the advertisement. A first user input is received on the client device in response to selection of the first option. The server provides one or more screens showing the plurality of tips in response to receiving an indication of the first user input. In response to the server, the client device displays the one or more screens showing the plurality of tips and displays a second option to modify the demographic parameters for the advertisement in accordance with the plurality of tips.

### RELATED APPLICATIONS

This application is a continuation-in-part of U.S. Non-Provisional patent application Ser. No. 29/587,671, filed Dec. 14, 2016, entitled “User Interface for an Advertisement Management Application,” which is incorporated by reference herein in its entirety.

### TECHNICAL FIELD

This relates generally to editing an advertising campaign of a user, including but not limited to adjusting demographic and interest targeting parameters relevant to the targeted audience for the advertisement.

### BACKGROUND

An advertiser may have one or more advertising campaigns under management. Although electronic devices make managing advertisements easily accessible, managing multiple advertisements and advertising campaigns can become cumbersome. Additionally, advertisements may need and/or be optimized for demographic and interest targeting parameter adjustments to remain relevant to their intended audiences.

### SUMMARY

Accordingly, there is a need for methods, systems, and interfaces for easily navigating a user through different settings to change demographic and interest targeted parameters of advertisements. For example, a user guide may contain useful tips on how to adjust demographic parameters or to target an audience based on interests.

In accordance with some embodiments, a method is performed at a client device having one or more processors and memory storing instructions for execution by the one or more processors. The method includes displaying to a user who manages an advertisement a first option of viewing one or more screens showing a plurality of tips for setting demographic parameters for the advertisement. The method further includes receiving a first user input selecting the first option, and in response to the first user input, displaying the one or more screens showing the plurality of tips. The method further includes displaying a second option to modify the demographic parameters for the advertisement in accordance with the plurality of tips.

In accordance with some embodiments, a client device includes one or more processors, memory, and one or more programs. The one or more programs are stored in the memory and configured to be executed by the one or more processors. The one or more programs include instructions for performing the operations of the method described above for the client device. In accordance with some embodiments, a non-transitory computer-readable storage medium stores instructions that, when executed by the client device, cause the client device to perform the operations of the method described above.

In accordance with some embodiments, a method is performed at a server with one or more processors and memory storing instructions for execution by the one or more processors. The method includes providing to a user of a client device who manages an advertisement a first option of viewing one or more screens displaying a plurality of tips for setting demographic parameters for the advertisement. The method further includes receiving an indication of a first user input selecting the first option, and in response to the receiving indication of the first user input, causing the electronic device to display one or more screens showing the plurality of tips. The method further includes providing a second option to modify the demographic parameters for the advertisement in accordance with the plurality of tips.

In accordance with some embodiments, a server system associated with an online service includes one or more processors and memory storing one or more programs for execution by the one or more processors. The one or more programs include instructions for performing the operations of the server-side method described above. In accordance with some embodiments, a non-transitory computer-readable storage medium stores instructions that, when executed by a server system, cause the server system to perform the operations of the server-side method described above.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating an exemplary network architecture, in accordance with some embodiments.

FIG. 2 is a block diagram illustrating an exemplary server system, in accordance with some embodiments.

FIG. 3 is a block diagram illustrating an exemplary client device, in accordance with some embodiments.

FIGS. 4A-4K illustrates exemplary graphical user interfaces (GUIs) on a client device for performing actions for an advertising campaign in accordance with some embodiments.

FIGS. 5A-5C illustrates a flow diagram illustrating a method of performing actions for an advertising campaign, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first user input could be termed a second user input, and, similarly, a second user input could be termed a first user input, without departing from the scope of the various described embodiments. The first user device and the second user input are both user inputs, but they are not the same user input.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

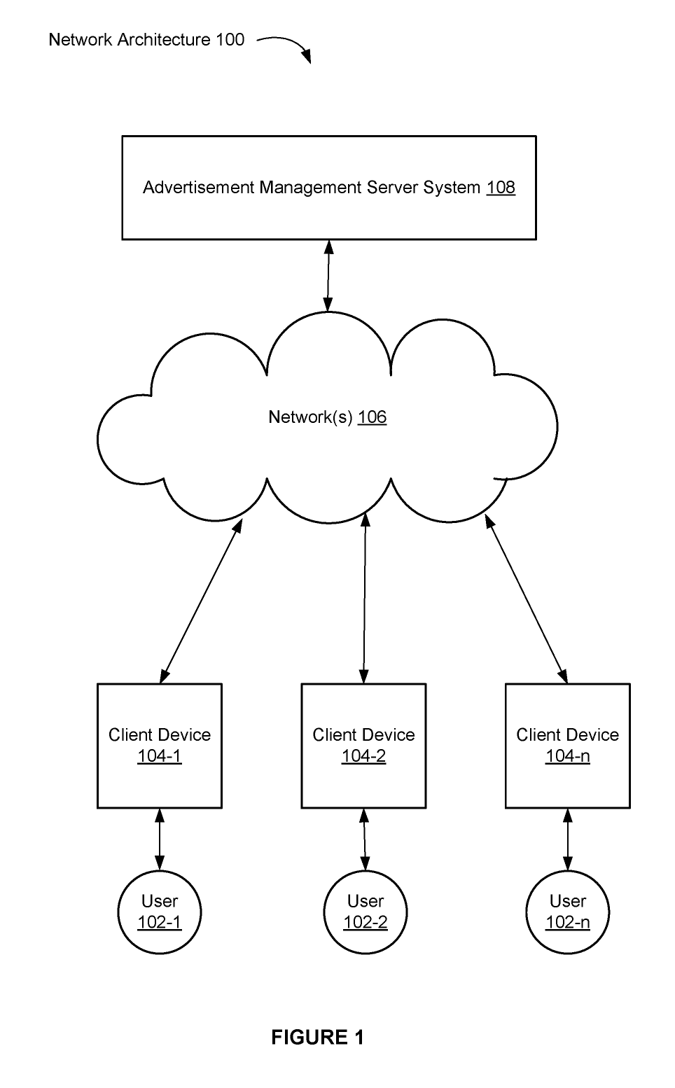

FIG. 1 is a block diagram illustrating an exemplary network architecture 100 for a type of online service, in accordance with some embodiments. The network architecture 100 includes a number of client devices (also called “client systems,” “client computers,” “user devices,” or “clients”) 104-1, 104-2, 104-n, communicably connected to an advertisement management server system 108) by one or more networks 106 (e.g., the Internet, cellular telephone networks, mobile data networks, other wide area networks, local area networks, metropolitan area networks, and so on). In some embodiments, the one or more networks 106 include a public communication network (e.g., the Internet and/or a cellular data network), a private communications network (e.g., a private LAN or leased lines), or a combination of such communication networks.

In some embodiments, the client devices 104-1, 104-2, 104-n are computing devices such as smart watches, personal digital assistants, portable media players, smart phones, tablet computers, 2D gaming devices, 3D gaming devices, virtual reality devices, laptop computers, desktop computers, televisions with one or more processors embedded therein or coupled thereto, in-vehicle information systems (e.g., an in-car computer system that provides navigation, entertainment, and/or other information), and/or other appropriate computing devices that can be used to communicate with the advertisement management system 108. In some embodiments, the advertisement management server system 108 is a single computing device such as a computer server, while in other embodiments, the advertisement management server system 108 is implemented by multiple computing devices working together to perform the actions of a server system (e.g., cloud computing).

User 102-1 employs the client device 104-1 to access the server system 108 to modify an existing advertisement. User 102-1 receives suggestions from the server system 108 to modify an existing advertisement. User 102-1 and client device 104-1 may be referred to as the first user and first user device. User 102-2 and client device 104-2 may be referred to as the second user and second user device.

In some embodiments, the advertisement management server system 108 is a server system for an advertisement management service provider that provides access to at least some services and/or features for third-party providers.

In connection with using or participating in a service provided by the advertisement management server system 108, the digital content that users may consume, provide, and/or otherwise interact with is accessible through various features or entry points. For example, digital content may be accessible and presented via one or more pages (e.g., user profile page, page for an entity or organization, etc.), feeds (e.g., a newsfeed, a user wall, a timeline, a notifications section for highlighting new/updates to digital content, etc.), applications, and/or other interfaces for specific types of digital content (e.g., interfaces for accessing private messages, accessing saved content, searching for content, etc.) maintained by and within the service. Pages are a type of digital document that may include some common elements of other web documents (e.g., document includes markup language, such as Hyper Text Markup Language (HTML), Extensible Markup Language (XML), Java, etc.). Pages may also include scripts (e.g., JavaScript inserted into the page by the advertisement management server system 108) for calling one or more application programming interfaces (APIs) of a server system for the social networking service (e.g., one or more APIs of the advertisement management server system 108, FIG. 1) to obtain user information (e.g., location information, payment credentials, profile information, etc. to be collected and stored in connection with using the social networking service). Scripts may be executed during a user's interaction with the loaded page (e.g., when the page is loaded, in response to a detected interaction within a loaded page, etc.).

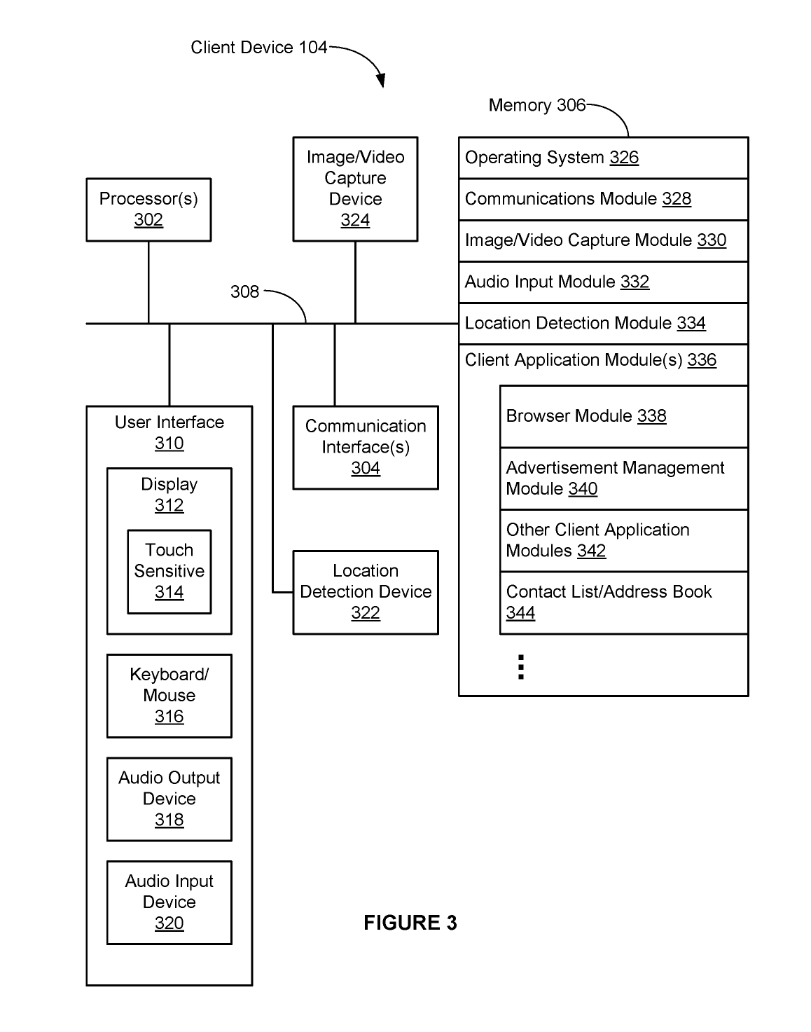

In some embodiments, a software application executing on a mobile client device, with proper permissions, may obtain information from hardware resources/components of the client device (e.g., image/video capture device 324, location detection device 322, microphone, sensors, etc., FIG. 3). For example, a global navigation satellite system (GNSS) (e.g., the global positioning system (GPS), GLONASS, Galileo, etc.) or other geo-location capabilities (e.g., Wi-Fi or hybrid positioning systems) may be accessed by a software application on the client device (e.g., advertisement management module 340, FIG. 3) to determine the user's location and update the advertisement management server system 108 with the user's location (e.g., “At Home,” “At Work,” or “In San Francisco, Calif.”), and/or update the advertisement management server system 108 with information derived from and/or based on the user's location.

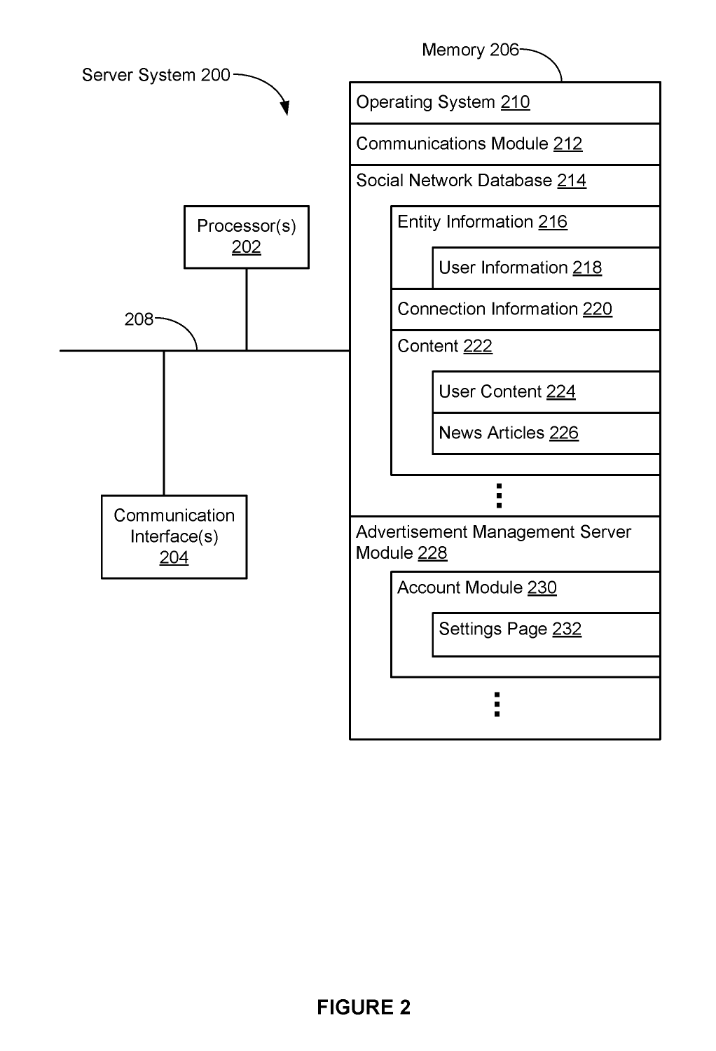

FIG. 2 is a block diagram illustrating an exemplary server system 200 (e.g. advertisement management server system 108), in accordance with some embodiments. The server system 200 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The server system 200 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 206 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 206 may optionally include one or more storage devices remotely located from the processor(s) 202. Memory 206, or alternately the non-volatile memory device(s) within memory 206, includes a non-transitory computer-readable storage medium. In some embodiments, memory 206 or the computer-readable storage medium of memory 206 stores the following programs, modules and data structures, or a subset or superset thereof:
an operating system 210 that includes procedures for handling various basic system services and for performing hardware dependent tasks;
a network communication module 212 that is used for connecting the server system 200 to other computers via the one or more communication network interfaces 204 (wired or wireless) and one or more communication networks (e.g., the one or more networks 106);
a social network database 214 for storing data associated with the social networking service, such as:
   entity information 216, such as user information 218,
   connection information 220; and
   content 222, such as:
      user content 224; and/or
      news articles 226;
an advertisement management server module 228 for providing advertisement management services and related features (e.g., in conjunction with advertisement management client module 340 on the client device 104, FIG. 3), which includes:
   an account module 230 for managing account information, including:
      a settings page 232 with fields for the user to input or modify advertisement related parameters;
      advertisements 234; and
      historical data 236 regarding advertisements.

The social network database 214 stores data associated with the social network in one or more types of databases, such as graph, dimensional, flat, hierarchical, text, network, object-oriented, relational, and/or XML databases. The account module 230 may similarly store settings, advertisements 234, and/or historical data 236 in one or more types of databases. Alternatively, the settings, advertisements 234, and/or historical data 236 are stored in the social network database 214.

In some embodiments, the social network database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities, some of which are rendered at clients 104 on corresponding profile pages or other pages in the social networking service. In some embodiments, the nodes also include pointers or references to other objects, data structures, or resources for use in rendering content in conjunction with the rendering of the pages corresponding to the respective nodes at clients 104.

Entity information 216 includes user information 218, such as user profiles, user profile pictures, a plurality of icons, login information, payment credentials (e.g., credit-card or debit-card information, bank information, etc. for conducting financial transactions through the social networking service), privacy and other preferences, biographical data, and the like. In some embodiments, for a given user, the user information 218 includes the user's name, profile picture, a plurality of icons, contact information, birth date, sex, marital status, family status, employment, education background, preferences, interests, and/or other demographic information.

In some embodiments, entity information 216 includes information about a physical location (e.g., a restaurant, theater, landmark, city, state, or country), real or intellectual property (e.g., a sculpture, painting, movie, game, song, idea/concept, photograph, or written work), a business, a group of people, and/or a group of businesses. In some embodiments, entity information 216 includes information about a resource, such as an audio file, a video file, a digital photo, a text file, a structured document (e.g., web page), or an application. In some embodiments, the resource is located in the advertisement management server system 108 (e.g., in content 222) or on an external server, such as third-party server 110.

In some embodiments, connection information 220 includes information about the relationships between entities in the social network database 214. In some embodiments, connection information 220 includes information about edges that connect pairs of nodes in a graph database. In some embodiments, an edge connecting a pair of nodes represents a relationship between the pair of nodes.

In some embodiments, an edge includes or represents one or more data objects or attributes that correspond to the relationship between a pair of nodes. In some embodiments, connection information 220 represents a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In some embodiments, content 222 and/or advertisements 234 include text (e.g., ASCII, SGML, HTML), images (e.g., jpeg, tif and gif), graphics (e.g., vector-based or bitmap), audio, video (e.g., mpeg), other multimedia, and/or combinations thereof. In some embodiments, content 222 and/or advertisements 234 includes executable code (e.g., script for API calls), podcasts, links, and the like.

In some embodiments, the advertisement management server module 228 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Python, Asynchronous JavaScript and XML (AJAX), XHP, Javelin, Wireless Universal Resource File (WURFL), and the like.

FIG. 3 is a block diagram illustrating an exemplary client device 104, in accordance with some embodiments. The client device 104 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 104 includes a user interface 310. The user interface 310 typically includes a display device 312. In some embodiments, the client device 104 includes inputs such as a keyboard, mouse, and/or other input buttons 316. Alternatively or in addition, in some embodiments, the display device 312 includes a touch-sensitive surface 314, in which case the display device 312 is a touch-sensitive display. In some embodiments, the touch-sensitive surface 314 is configured to detect various swipe gestures (e.g., continuous gestures in vertical and/or horizontal directions) and/or other gestures (e.g., single/double tap). In client devices that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 104 use a microphone and voice recognition to supplement or replace the keyboard. Optionally, the client device 104 includes an audio input device 320 (e.g., a microphone) to capture audio (e.g., speech from a user). Optionally, the client device 104 includes a location detection device 322, such as a GNSS (e.g., GPS, GLONASS, Galileo, etc.) or other geo-location receiver, for determining the location of the client device 104. The client device 104 also optionally includes an image/video capture device 324, such as a camera or webcam.

In some embodiments, the client device 104 includes one or more optional sensors (e.g., gyroscope, accelerometer, inertial measurement unit (IMU)) for detecting a motion and/or change in orientation of the client device. In some embodiments, a detected motion and/or orientation of the client device 104 (e.g., the motion/change in orientation corresponding to a user input produced by a user of the client device) is used to manipulate an interface (or content within the interface) displayed on the client device 104.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 302. Memory 306, or alternately the non-volatile memory device(s) within memory 306, includes a non-transitory computer-readable storage medium. In some embodiments, memory 306 or the computer-readable storage medium of memory 306 stores the following programs, modules, and data structures, or a subset or superset thereof:
an operating system 326 that includes procedures for handling various basic system services and for performing hardware dependent tasks;
a network communication module 328 that is used for connecting the client device 104 to other computers via the one or more communication network interfaces 304 (wired or wireless) and one or more communication networks, such as the Internet, cellular telephone networks, mobile data networks, other wide area networks, local area networks, metropolitan area networks, and so on;
an image/video capture module 330 (e.g., a camera module) for processing a respective image or video captured by the image/video capture device 324, where the respective image or video may be sent or streamed (e.g., by a client application module 336) to the advertisement management server system 108;
an audio input module 332 (e.g., a microphone module) for processing audio captured by the audio input device 320, where the respective audio may be sent or streamed (e.g., by a client application module 336) to the advertisement management server system 108;
a location detection module 334 (e.g., a GNSS, Wi-Fi, or hybrid positioning module) for determining the location of the client device 104 (e.g., using the location detection device 322) and providing this location information for use in various applications (e.g., advertisement management module 340); and
one or more client application modules 336, including the following modules (or sets of instructions), or a subset or superset thereof:
   a web browser module 338 (e.g., Internet Explorer or Edge by Microsoft, Firefox by Mozilla, Safari by Apple, or Chrome by Google) for accessing, viewing, and interacting with web sites;
   an advertisement management module 340 for providing an interface to an advertisement management service (e.g., an advertisement management service provided by advertisement management server system 108) and related features;
   optional client application modules 342, such as applications for social networking, word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D gaming, virtual-reality applications, electronic book readers, fitness, and/or workout support; and/or
   contact list and/or address book module 344 for storing contact information including names, phone numbers, and other personal information corresponding to the contact.

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures, or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

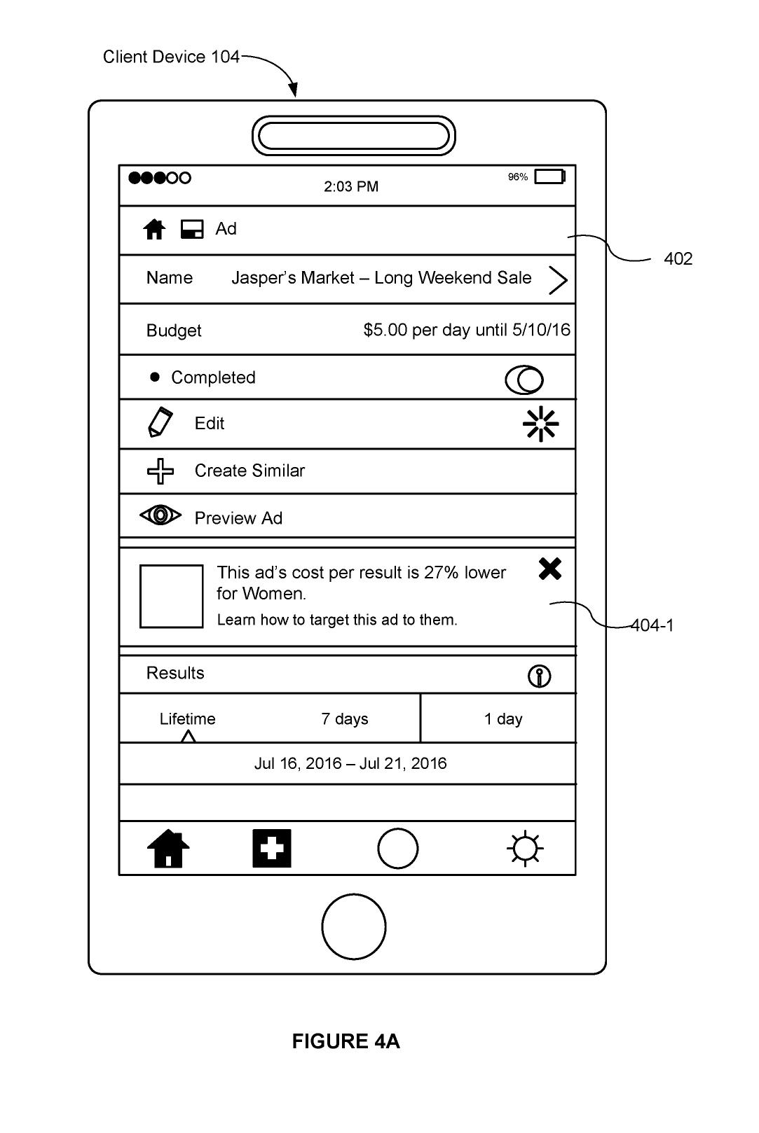

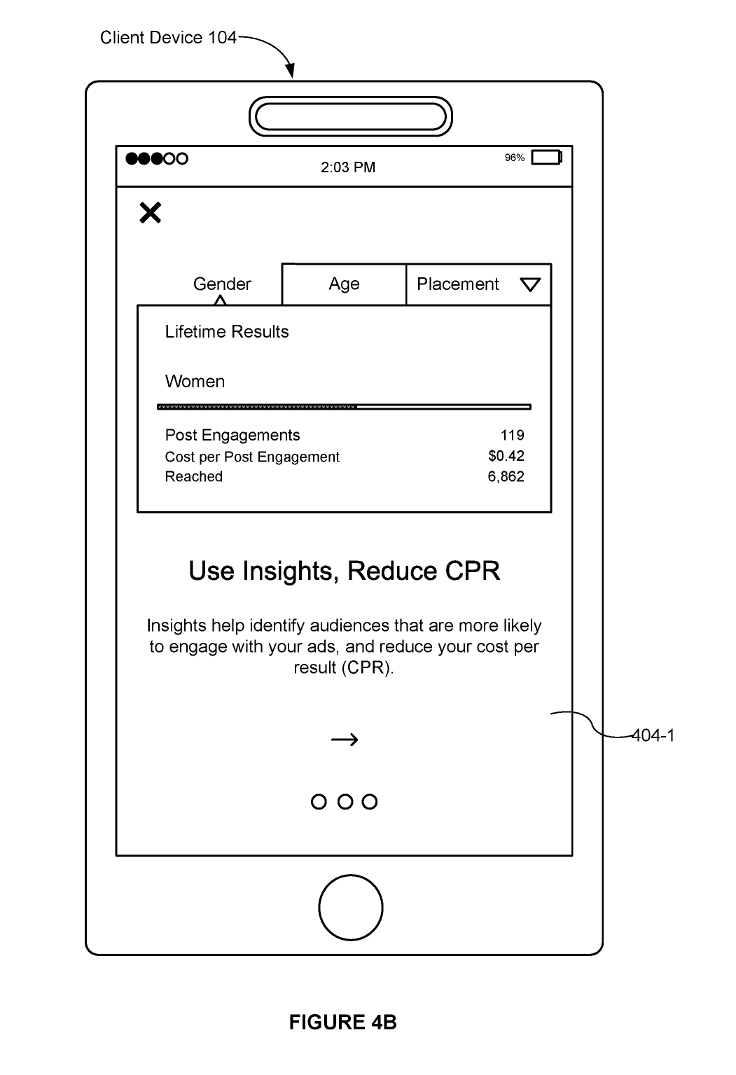

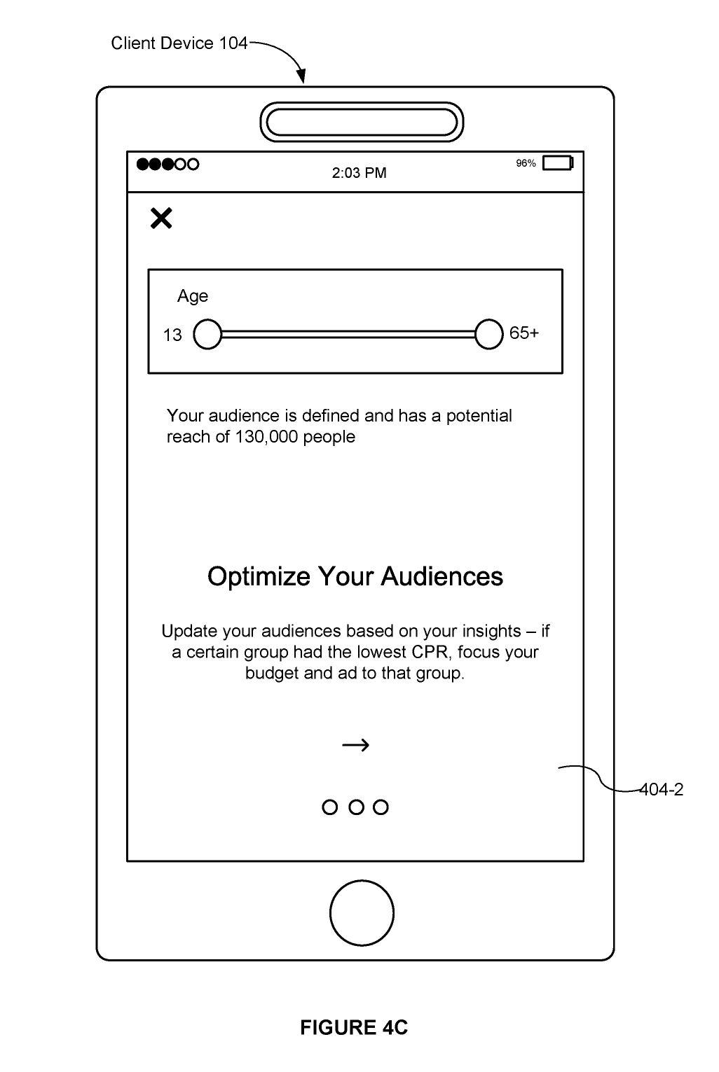

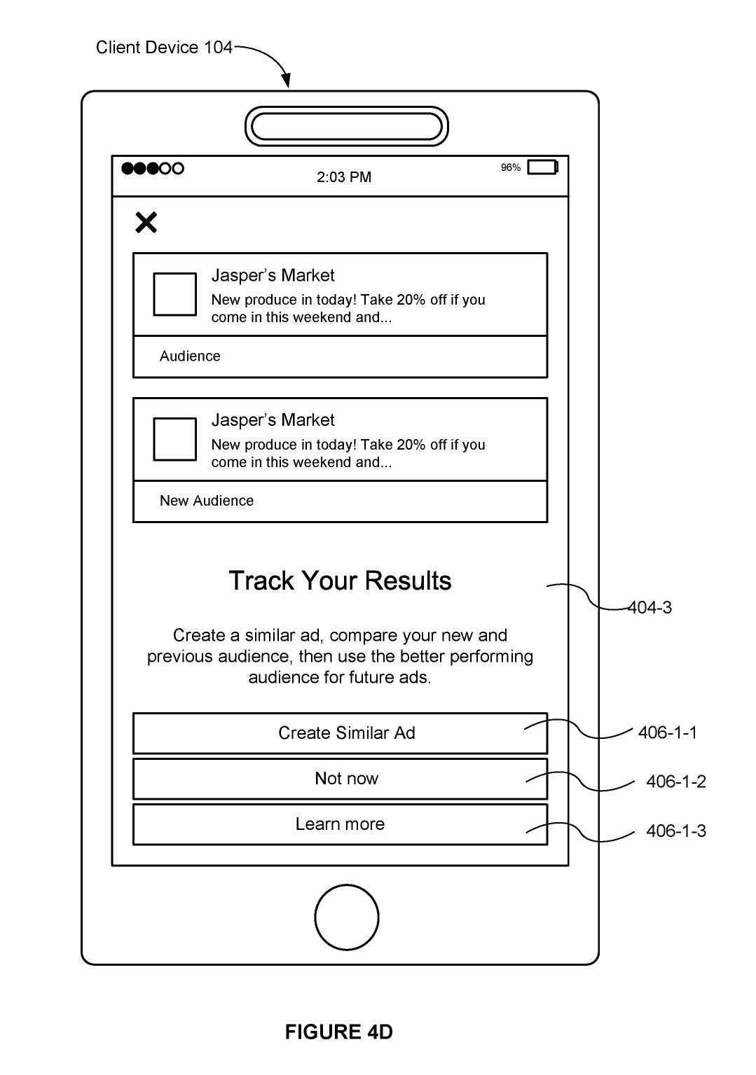

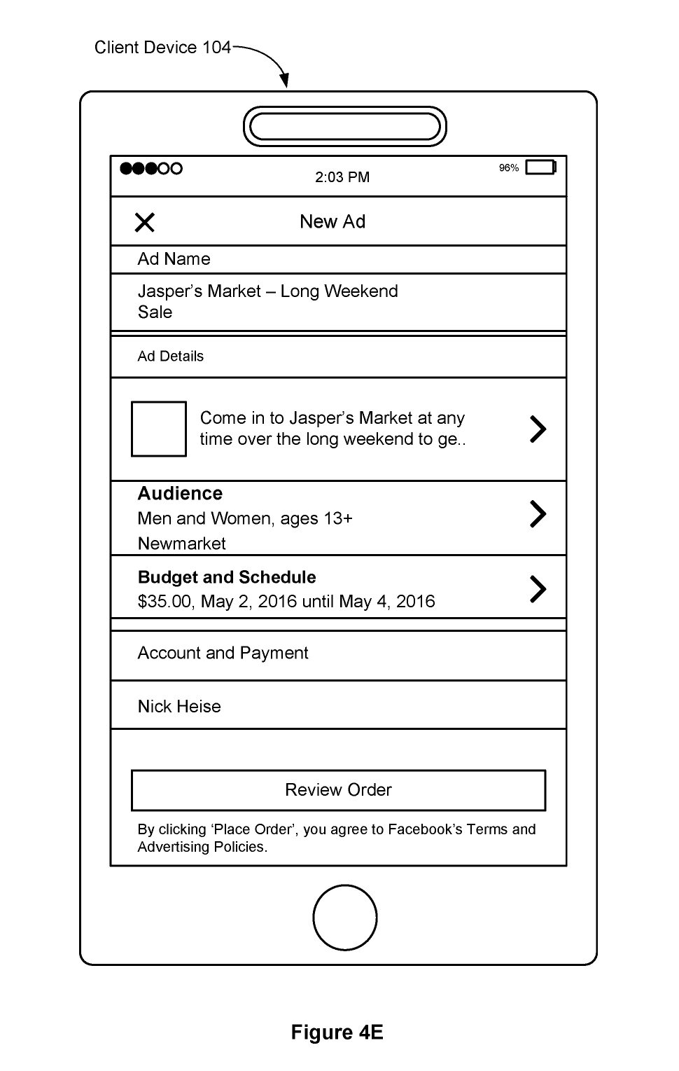

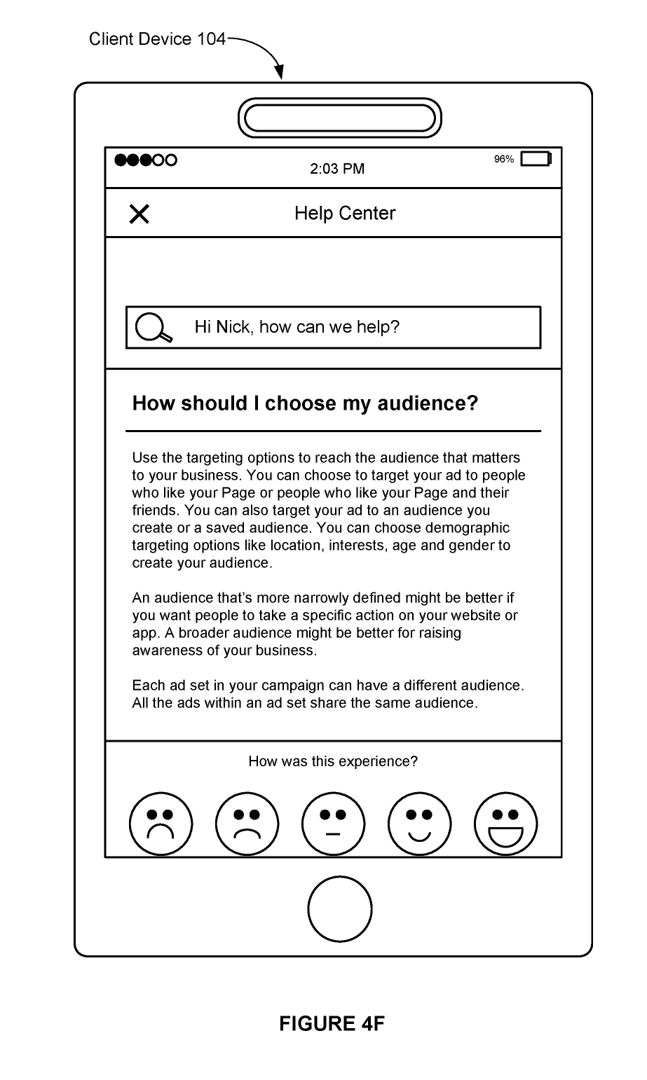

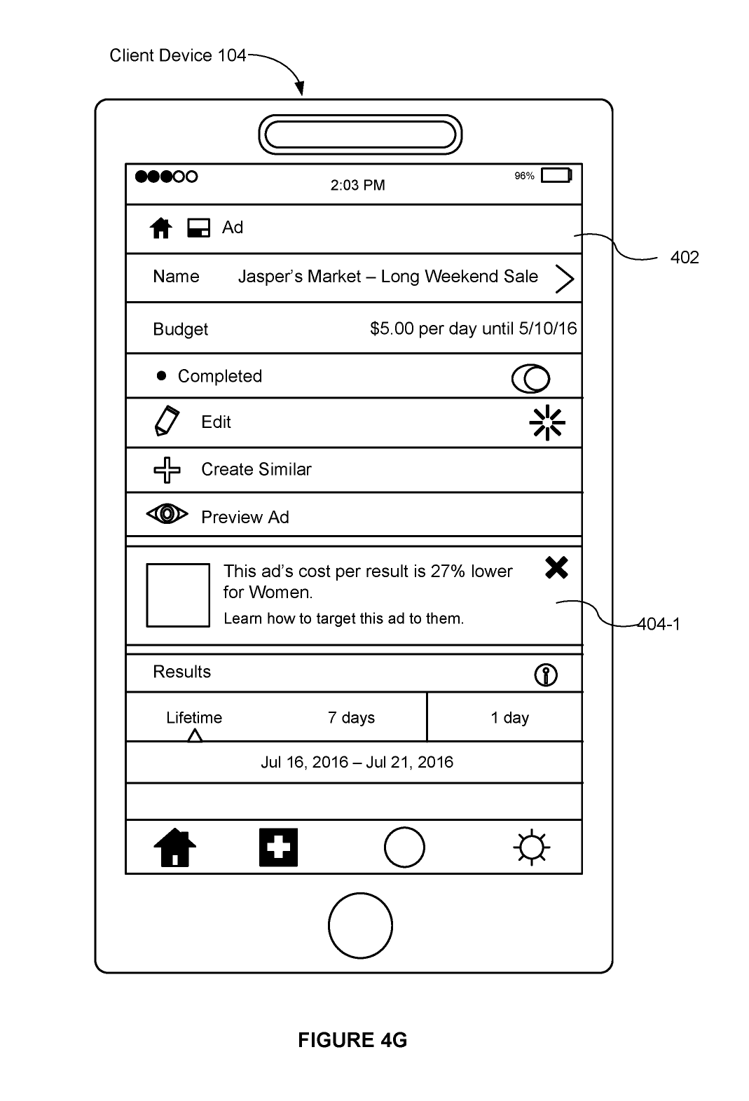

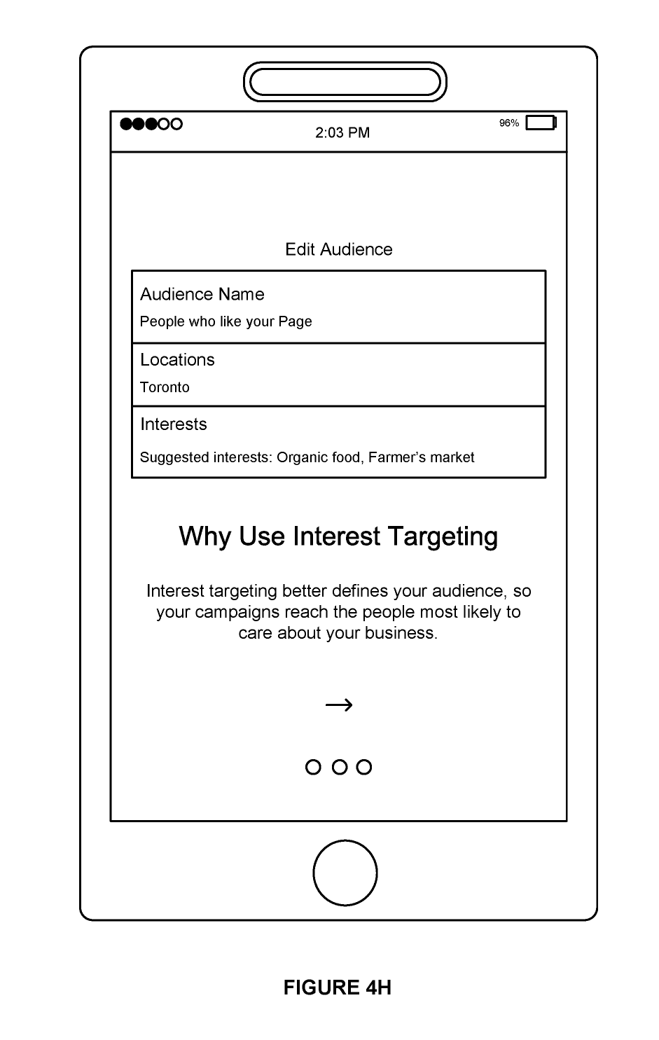

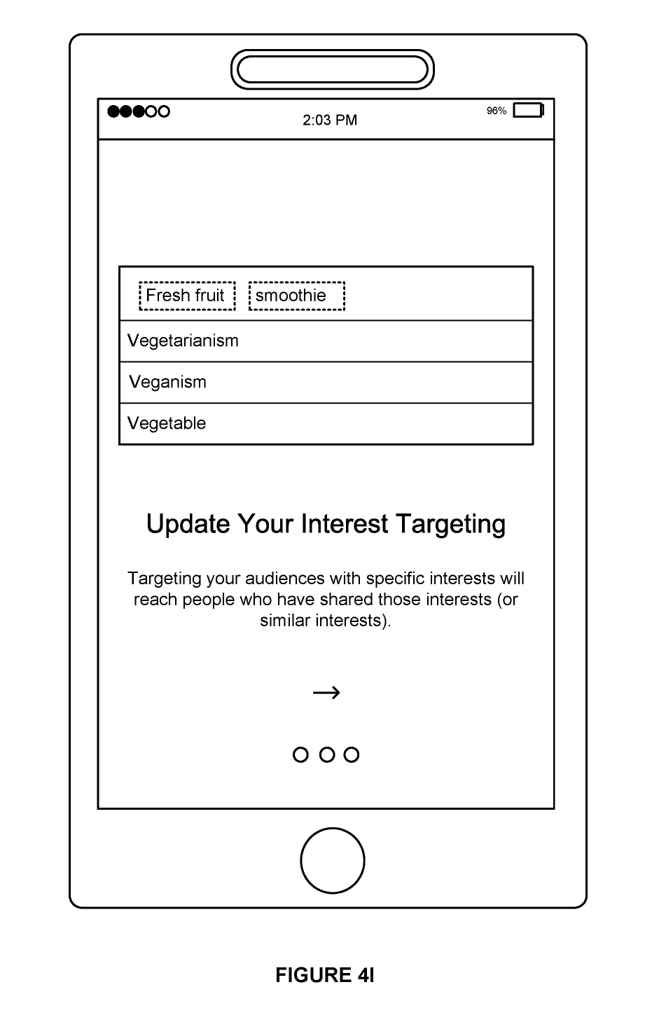

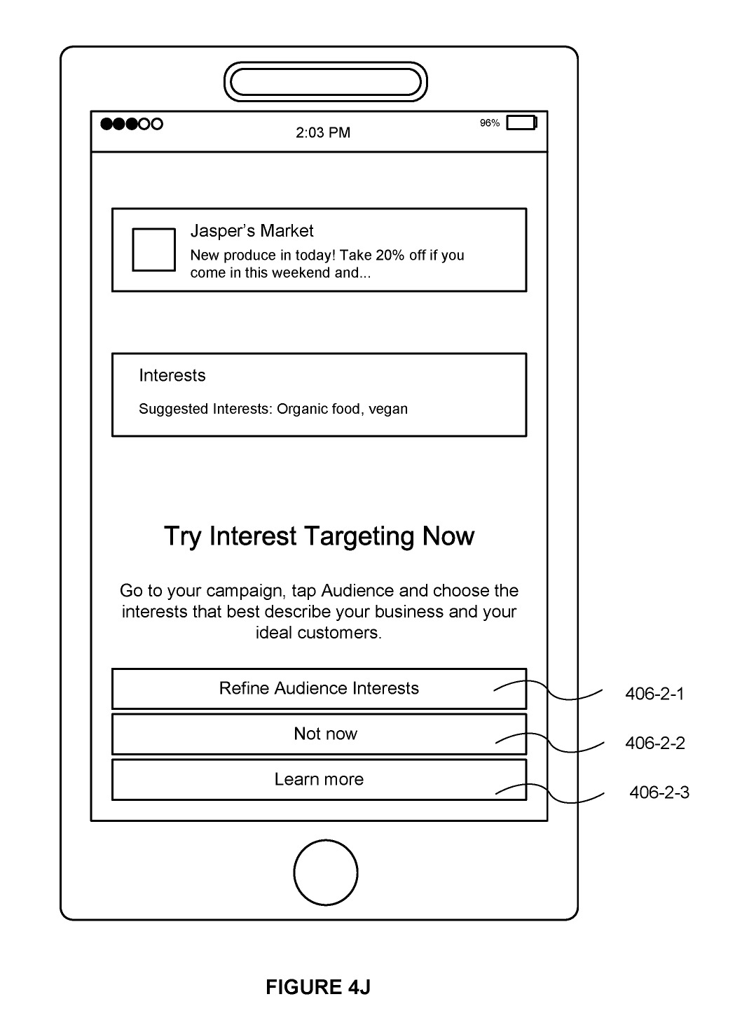

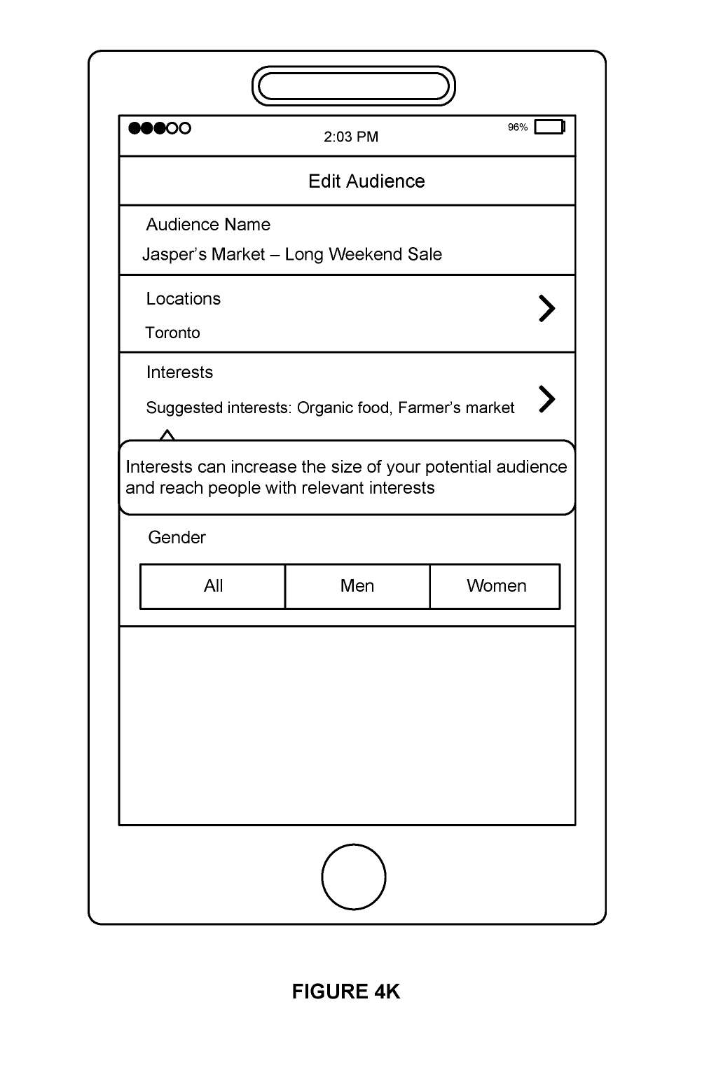

Attention is now directed towards embodiments of graphical user interfaces (“GUIs”) and associated processes that may be implemented on a client device (e.g., the client device 104-1 in FIG. 4A).

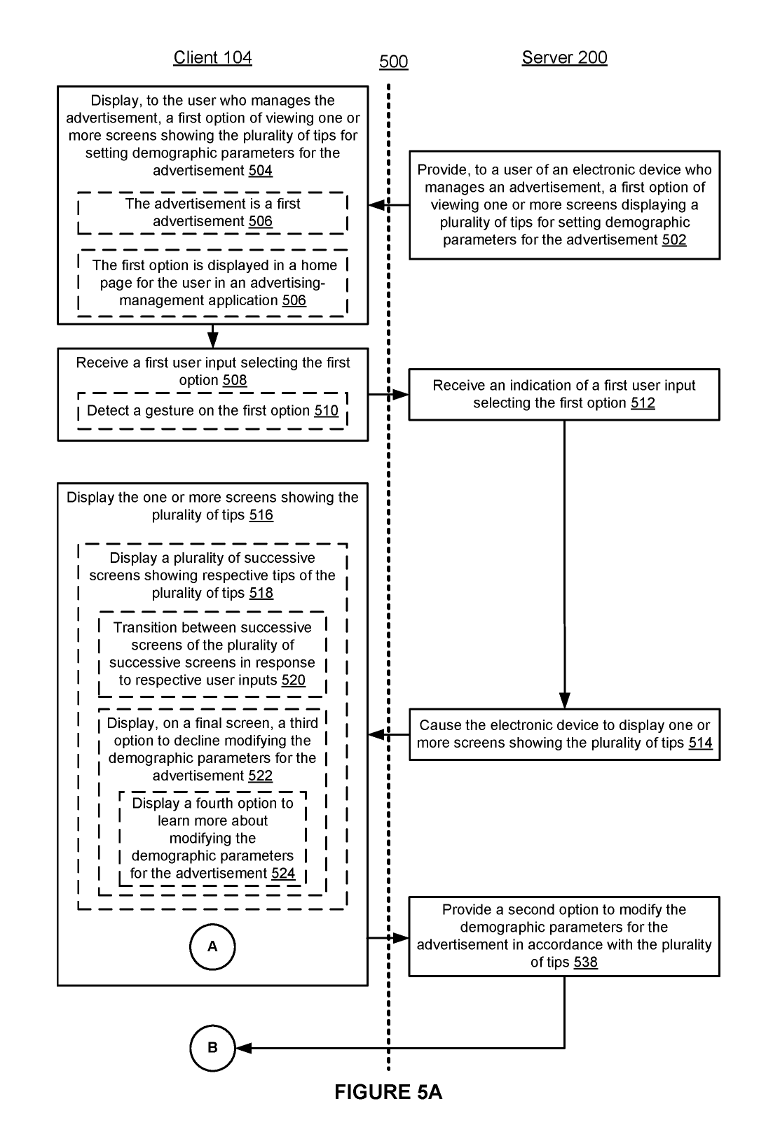

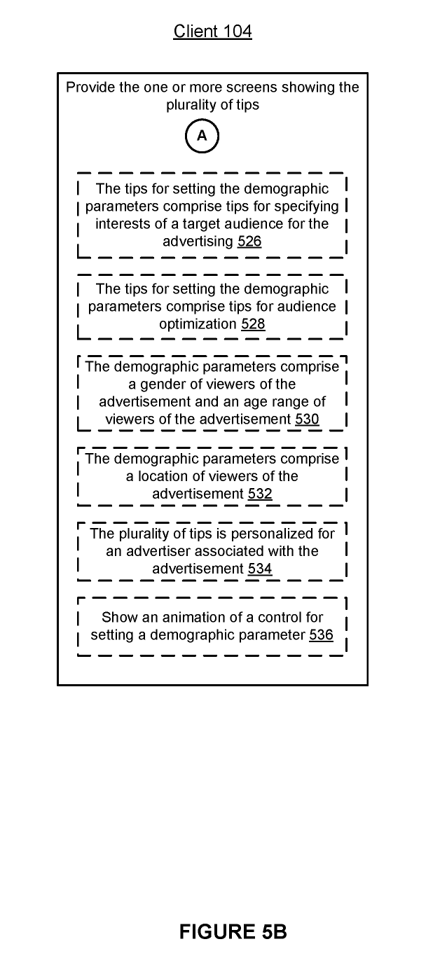

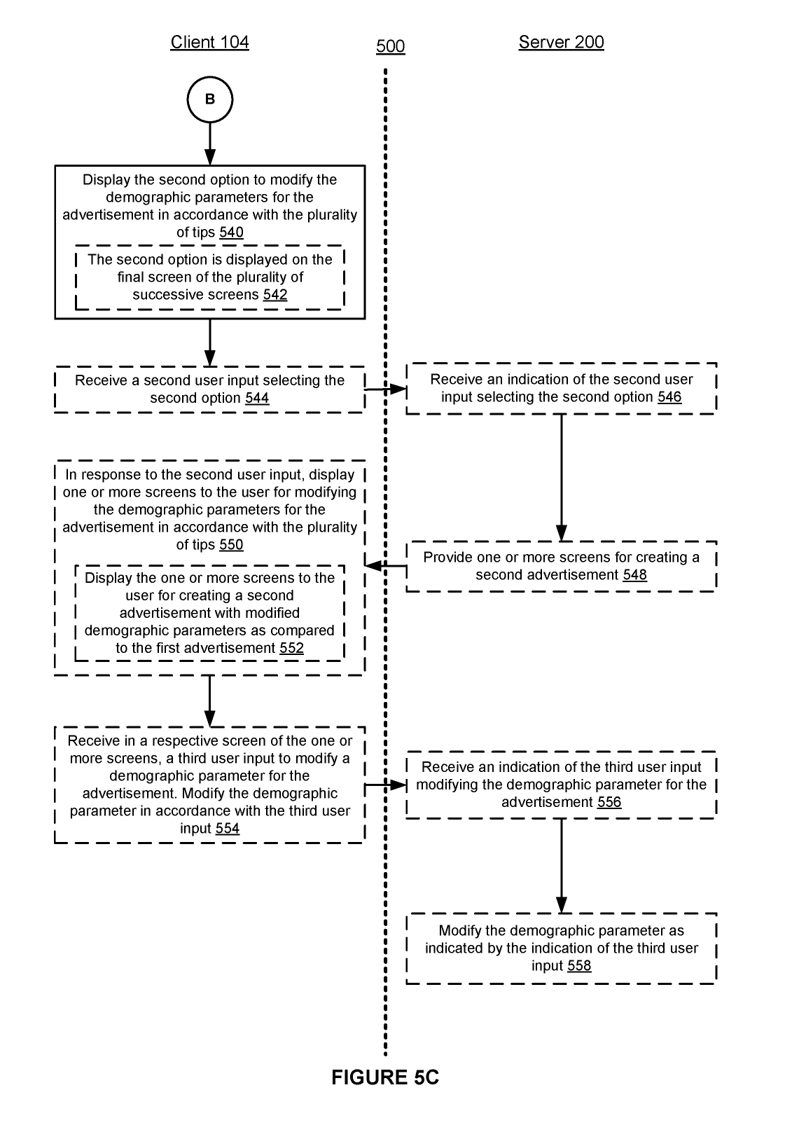

FIGS. 4A-4K illustrate exemplary GUIs on a first client device 104 for performing actions for an advertisement in an advertising campaign. The GUIs shown may be provided by an application for managing advertisements (e.g., advertisement management module 340, FIG. 3). In some embodiments, the application for managing advertisements is also an application for a social networking service. The GUIs in these figures are used to illustrate the processes described below, including the method 500 (FIG. 5A-5C). While FIGS. 4A-4K illustrate examples of GUIs, in other embodiments, one or more GUIs may display user-interface elements in arrangements distinct from the embodiments of FIGS. 4A-4K.

FIGS. 5A-5C are flow diagrams illustrating a method 500 of editing an advertising campaign of a user, including performing actions recommended to the user, in accordance with some embodiments.

The steps of the method 500 may be performed by a client device 104 (FIGS. 1, 3, 4A-4K) (i.e., a user device) and/or a server system 200 (FIG. 2) (e.g., advertisement management server system 108, FIG. 1). FIGS. 5A-5C correspond to instructions stored in computer memory (e.g., memory 306 of the client device 104, FIG. 3; memory 206 of the advertisement management server system 108, FIG. 2) or another computer-readable storage medium. To assist with describing the method 500, FIG. 5 will be described with reference to the exemplary GUIs illustrated in FIGS. 4A-4K.

In some embodiments, in performing the method 500, the server system 200 provides 502, to a user of an electronic device who manages an advertisement, a first option of viewing one or more screens displaying a plurality of tips for setting demographic parameters for the advertisement. For example in FIG. 4A, the client device 104 displays a first option 402 of viewing tips for setting demographic parameters.

In some embodiments, the client device 104 displays 504, to the user who manages the advertisement, a first option 404-1 of viewing one or more screens showing the plurality of tips 412 for setting demographic parameters for the advertisement. In some embodiments, the advertisement is a first advertisement 506. In some embodiments, the first option is displayed 506 in a home page for the user in an advertising management application. For example, FIG. 4A includes a first option 402 displayed in a home page 400 for the user indicating an option to select the option of viewing tips on how to set demographic parameters for the advertisement.

The client device 104 receives 508 a first user input selecting the first option. In some embodiments, the client device 104 detects 510 a gesture on the first option.

In some embodiments, the server 200 receives 512 an indication of a first user input selecting the first option.

In some embodiments, the server 200 causes the client device 104 to display 514 one or more screens (FIGS. 4B-4D 404-1, 404-2, 404-3 or FIGS. 4H-4J 408-1, 408-2, 408-3) showing the plurality of tips. For example, FIGS. 4B-4D and 4H-4J show screens (FIGS. 4B-4D 404-1, 404-2, 404-3 or FIGS. 4H-4J 408-1, 408-2, 408-3) including tips (412-1, 412-2, 412-3,412-4, 412-5, 412-6) for setting demographic parameters for the advertisement.

In some embodiments, the client device 104 displays 516 the one or more screens (404-1, 404-2, 404-3) showing the plurality of tips. In some embodiments, the client device 104 displays 518 a plurality of successive screens showing respective tips of the plurality of tips. For example, FIGS. 4B-4D and 4H-4J show screens (FIGS. 4B-4D 404-1, 404-2, 404-3 or FIGS. 4H-4J 408-1, 408-2, 408-3) including tips (412-1, 412-2, 412-3,412-4, 412-5, 412-6) for setting demographic parameters for the advertisement.

In some embodiments, the client device 104 transitions 520 between successive screens of the plurality of successive screens in response to respective user inputs. In some embodiments, the client device 105 displays 522 (FIG. 5B), on a final screen, a second option to modify the demographic parameters for the advertisement. For example, FIGS. 4E and 4K display user interfaces of the client device 104 related to creating a new advertisement 410 or editing an audience 414.

In some embodiments, the client device 105 displays 522 (FIG. 5B), on a final screen, a third option to decline modifying the demographic parameters for the advertisement. For example, in FIGS. 4D and 4J, selecting the third option (406-1-2, 406-2-2) to decline modifying the demographic parameter returns the user of the client device 104 to the home screen 400.

In some embodiments, the tips (412-1, 412-2, 412-3,412-4, 412-5, 412-6) for setting 526 the demographic parameters comprise tips for specifying interests of a target audience for the advertising. For example, FIG. 4J shows a user interface that includes an option to “Refine Audience Interests” 406-2-1 for setting parameters specifying targeting the interests of a target audience.

In some embodiments the tips for setting 528 the demographic parameters comprise tips for audience optimization. In some embodiments, the demographic parameters 530 comprise a gender of viewers of the advertisement and an age range of viewers of the advertisement. In some embodiments, the demographic parameters 532 comprise a location of viewers for the advertisement. For example, FIG. 4B-4D include tips (412-1, 412-2, 412-3,412-4, 412-5, 412-6) for audience optimization by offering tips to adjust the settings of the target gender, age range, and locations of viewers.

In some embodiments, the plurality of tips is personalized 534 for an advertiser associated with the advertisement. In some embodiments, the client device 104 shows 536 an animation of a control for setting a demographic parameter.

In some embodiments, the server 200 provides 538 (FIG. 5A) a second option 406-1-1, 406-2-1 to the client device 104 to modify the demographic parameters for the advertisement in accordance with the plurality of tips.

In some embodiments, the client device 104 displays 540 (FIG. 5C) the second option to modify the demographic parameters for the advertisement in accordance with the plurality of tips. In some embodiments, the second option is displayed 542 on the final screen of the plurality of successive screens. For example, FIGS. 4D and 4J show the second option 406-1-1, 406-2-1 displayed on the final screen of the plurality of successive screens.

In some embodiments, the client device 104 receives 544 a second user input selecting the second option.

In some embodiments, the server 200 receives 546 an indication of the second user input selecting the second option.

In some embodiments, the server 200 provides 548 one or more screens for creating a second advertisement. For example, FIG. 4E shows a user interface of the client device 104 for creating a new advertisement.

In some embodiments, the client device 104 in response to the second user input, displays 550 one or more screens to the user for modifying the demographic parameters for the advertisement in accordance with the plurality of tips. In some embodiments the one or more screens to the user for creating a second advertisement are displayed 552 with modified demographic parameters as compared to the first advertisement. For example, FIG. 4E shows a user interface on the client device 104 to create a new advertisement 410 with modified demographic parameters as compared to the first advertisement.

In some embodiments, the client device 104 receives 554, in a respective screen of the one or more screens, a third user input to modify a demographic parameter for the advertisement. In response, the demographic parameter may be modified in accordance with the third user input.

In some embodiments, the server 200 receives 556 an indication of the third user input modifying the demographic parameter for the advertisement. In some embodiments, the server 200 modifies 558 the demographic parameter as indicated by the indication of the third user input.

While the method 500 includes a number of operations that appear to occur in a specific order, the method 500 can include more or fewer operations. For example, steps 544-558 may be omitted. Some operations can be executed serially or in parallel, an order of two or more operations may be changed, and/or two or more operations may be combined into a single operation.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at an electronic device with a display, one or more processors, and memory storing one or more programs for execution by the one or more processors:
displaying, to a user who manages an advertisement, a first option of viewing one or more screens showing a plurality of tips for setting demographic parameters for the advertisement;
receiving a first user input selecting the first option;
in response to the first user input, displaying the one or more screens showing the plurality of tips; and
displaying a second option to modify the demographic parameters for the advertisement in accordance with the plurality of tips.

2. The method of claim 1, wherein:
displaying the one or more screens comprises displaying a plurality of successive screens showing respective tips of the plurality of tips; and
the second option is displayed on a final screen of the plurality of successive screens.

3. The method of claim 2, further comprising, at the electronic device, transitioning between successive screens of the plurality of successive screens in response to respective user inputs.

4. The method of claim 2, further comprising, at the electronic device, on the final screen, displaying a third option to decline modifying the demographic parameters for the advertisement.

5. The method of claim 4, further comprising, at the electronic device, on the final screen, displaying a fourth option to learn more about modifying the demographic parameters for the advertisement.

6. The method of claim 1, further comprising, at the electronic device:
receiving a second user input selecting the second option; and
in response to the second user input, displaying one or more screens to the user for modifying the demographic parameters for the advertisement in accordance with the plurality of tips.

7. The method of claim 6, further comprising, at the electronic device:
receiving, in a respective screen of the one or more screens, a third user input to modify a demographic parameter for the advertisement; and
modifying the demographic parameter in accordance with the third user input.

8. The method of claim 1, wherein the advertisement is a first advertisement, the method further comprising, at the electronic device:
receiving a second user input selecting the second option; and
in response to the second user input, displaying one or more screens to the user for creating a second advertisement with modified demographic parameters as compared to the first advertisement.

9. The method of claim 1, wherein the tips for setting the demographic parameters comprise tips for specifying interests of a target audience for the advertising.

10. The method of claim 1, wherein the tips for setting the demographic parameters comprise tips for audience optimization.

11. The method of claim 1, wherein the demographic parameters comprise a gender of viewers of the advertisement and an age range of viewers of the advertisement.

12. The method of claim 1, wherein the demographic parameters comprise a location of viewers of the advertisement.

13. The method of claim 1, wherein the first option is displayed in a home page for the user in an advertising-management application.

14. The method of claim 1, wherein the plurality of tips is personalized for an advertiser associated with the advertisement.

15. The method of claim 1, wherein displaying the one or more screens showing the plurality of tips comprises showing an animation of a control for setting a demographic parameter.

16. The method of claim 1, wherein receiving the first user input comprises detecting a gesture on the first option.

17. A non-transitory computer readable storage medium storing one or more programs for execution by one or more processors of an electronic device, the one or more programs including instructions for:
displaying to a user who manages an advertisement, a first option of viewing one or more screens showing a plurality of tips for setting demographic parameters for the advertisement;
receiving a first user input selecting the first option;
in response to the first user input, displaying the one or more screens showing the plurality of tips; and
displaying a second option to modify the demographic parameters for the advertisement in accordance with the plurality of tips.

18. A method, comprising:
at a server with one or more processors and memory storing one or more programs for execution by the one or more processors:
providing to a user of an electronic device who manages an advertisement, a first option of viewing one or more screens displaying a plurality of tips for setting demographic parameters for the advertisement;
receiving an indication of a first user input selecting the first option;
in response to the received indication of the first user input, causing the electronic device to display one or more screens showing the plurality of tips; and
providing a second option to modify the demographic parameters for the advertisement in accordance with the plurality of tips.
